(19) United States
(12) Patent Application Publication
(10) Pub. No.: US 2014/0211072 A1
(43) Pub. Date: Jul. 31, 2014

(54) OPTICAL DEVICE, SOLID-STATE IMAGING DEVICE AND METHOD FOR MANUFACTURING THE OPTICAL DEVICE

(71) Applicant: Kabushiki Kaisha Toshiba, Minato-ku (JP)

(72) Inventor: Koichi KOKUBUN, Kanagawa-ken (JP)

(21) Appl. No.: 13/915,935

(22) Filed: Jun. 12, 2013

(30) Foreign Application Priority Data
Jan. 30, 2013 (JP) 2013-015621

(51) Int. Cl. G02B 1/00; H04N 5/225

(52) U.S. Cl. CPC G02B 1/002; H04N 5/2254
USPC 348/340; 359/642; 216/26

(57) ABSTRACT

According to one embodiment, an optical device includes a substrate and a first optical layer. The substrate has a first surface and a second surface. The second surface is on an opposite side of the first surface. The first optical layer is provided on the first surface and includes a plurality of first refractive index setting units disposed along the first surface. Each of the first refractive index setting units has a plurality of metal patterns. The metal patterns provide different permeability to the each of the first refractive index setting units. The each of the first refractive index setting units has a refractive index in accordance with the permeability.

### CROSS-REFERENCE TO RELATED APPLICATIONS

This application is based upon and claims the benefit of priority from Japanese Patent Application No. 2013-015621, filed on Jan. 30, 2013; the entire contents of which are incorporated herein by reference.

### FIELD

Embodiments described herein relate generally to an optical device, a solid-state imaging device and a method for manufacturing the optical device.

### BACKGROUND

It is necessary to use a high refractive index material in order to make a thickness of lens of an optical device thin. For example, when using SiO₂-based glass as the lens, a refractive index of SiO₂ is about 1.45. If the refractive index of the lens is, for example, 3, the thickness of the lens is reduced to about ⅓ times compared with using SiO₂-based glass.

A refractive index is determined by a product of square root of each of a dielectric constant and permeability. Therefore, if one of the dielectric constant and the permeability can be large, the refractive index can be high. In the optical device, it is favorable to obtain a desired refractive index.

### BRIEF DESCRIPTION OF THE DRAWINGS

FIG. 1A and FIG. 1B are schematic views illustrating an optical device according to a first embodiment;

FIG. 2A and FIG. 2B are schematic views illustrating a metal pattern;

FIG. 3A and FIG. 3B are schematic views illustrating a layout of the metal pattern;

FIG. 4A and FIG. 4B show the definition in performing an optical simulation;

FIG. 5A and FIG. 5B show results of the optical simulation;

FIG. 6A and FIG. 6B are schematic views showing variation examples of geometrical features of the metal pattern;

FIG. 7A to FIG. 7C are schematic cross-sectional views illustrating a method for manufacturing the optical device;

FIG. 8A and FIG. 8B are schematic cross-sectional views illustrating a method for manufacturing the optical device;

FIG. 9A and FIG. 9B are schematic cross-sectional views illustrating optical devices according to a third embodiment;

FIG. 10A and FIG. 10B are schematic views illustrating the disposition of two metal patterns;

FIG. 11A and FIG. 11B are schematic views illustrating distances between the two metal patterns;

FIG. 12A and FIG. 12B are schematic views illustrating other shapes of the metal patterns;

FIG. 13 shows the optical simulation result;

FIG. 14A and FIG. 14B are schematic views illustrating other shapes of the metal patterns;

FIG. 15 is a schematic view illustrating another configuration of the optical device;

FIG. 16 is a schematic cross-sectional view illustrating a sold-state imaging device according to a fourth embodiment;

FIG. 17 is a schematic cross-sectional view illustrating a solid-state imaging device according to a reference example; and

FIG. 18 is a schematic cross-sectional view illustrating another solid-sate imaging device according to the fourth embodiment.

### DETAILED DESCRIPTION

According to one embodiment, an optical device includes a substrate and a first optical layer. The substrate has a first surface and a second surface. The second surface is on an opposite side of the first surface. The first optical layer is provided on the first surface and includes a plurality of first refractive index setting units disposed along the first surface. Each of the first refractive index setting units has a plurality of metal patterns. The metal patterns provide different permeability to the each of the first refractive index setting units. The each of the first refractive index setting units has a refractive index in accordance with the permeability.

Various embodiments will be described hereinafter with reference to the accompanying drawings. In the following description, the same reference numbers are applied to the same members, and the description will be omitted about the members once described as appropriate.

### First Embodiment

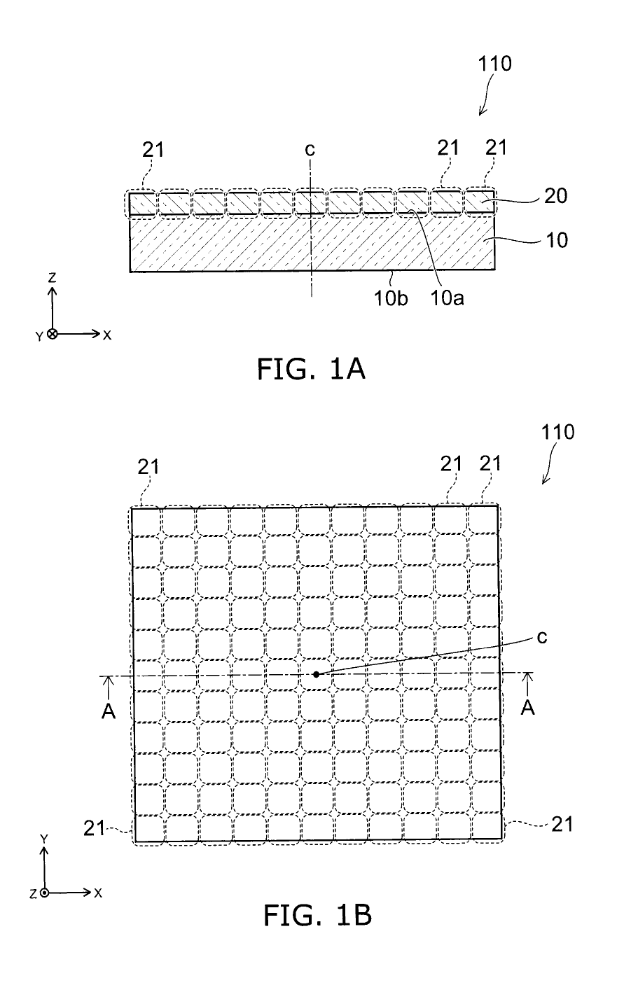

FIG. 1A and FIG. 1B are schematic views illustrating an optical device according to a first embodiment.

FIG. 1A shows a schematic cross-sectional view of an optical device 110. FIG. 1B shows a schematic plan view of the optical device 110. FIG. 1A shows a schematic cross-sectional view along A-A line of FIG. 1B.

The optical device 110 according to the first embodiment includes a substrate 10 and a first optical layer 20. The optical device 110 functions as an optical lens. The substrate 10 is formed of a material transmitting a light of a prescribed wavelength. In the embodiment, the substrate 10 is formed of, for example, a material (SiO₂ etc.) transmitting a visible light. Here, the visible light has a wavelength not less than 360 nanometers (nm) and not more than 830 nanometers (nm).

The substrate 10 has a first surface 10a and a second surface 10b on an opposite side to the first surface 10a. The substrate 10 has, for example, a flat plate shape. As shown in FIG. 1A, the first surface 10a is, for example, parallel to the second surface 10b. In the embodiment, a direction perpendicular to the first surface 10a is taken as a Z-direction, one of directions perpendicular to the Z-direction is taken as an X-direction, and a direction perpendicular to the Z-direction and the Y-direction is taken as a Y-direction. An optical axis c in the optical device 110 is, for example, the Z-direction. The light passes through, for example, the first optical layer 20, enters the first surface 10a of the substrate 10 and emits from the second surface 10b.

A thickness of the substrate 10 (a distance between the first surface 10a and the second surface 10b in the Z-direction) is, for example, determined by an optical path length functioning as the optical lens. As shown in FIG. 1B, an outline of the substrate 10 as viewed in the Z-direction is, for example, rectangular. The outline of the substrate 10 as viewed in the Z-direction may be circular or the like other than rectangular.

The first optical layer 20 is provided on the first surface 10a of the substrate 10. The first optical layer 20 includes a plurality of first refractive index setting units 21. In the drawing describing the embodiment, for convenience of description, the first refractive index setting units 21 are shown by a broken line. As shown in FIG. 1B, the plurality of refractive index setting units 21 are disposed in a two-dimensional configuration along the first surface 10a.

In the example shown in FIG. 1B, the plurality of refractive index setting units 21 are disposed in the X-direction and the Y-direction, respectively. That is, the plurality of refractive index setting units 21 are disposed in a matrix configuration along the first surface 10a. The arrangement of the plurality of refractive index setting units 21 is not limited to a matrix configuration.

Each of the plurality of first refractive index setting units has a plurality of metal patterns providing different permeability to the each. That is, the permeability of the first refractive index setting units 21 is adjusted by the plurality of metal patterns. Each of the plurality of first refractive index setting units 21 has the refractive index in accordance with the permeability, namely has the refractive index set by the plurality of metal patterns.

The first refractive index setting units 21 provided with the plurality of metal patterns are so called meta-material. The meta-material is an artificial material having characteristics formed by arranging a metal periodically with a certain pattern and not found in nature.

In the following, the case of providing two metal patterns is described illustratively as one example of the plurality of metal patterns. However, the embodiment is not limited thereto, three or more metal pattern may be provided in the first refractive index setting units 21.

In the optical device 110, the refractive index is set depending on respective positions in the X, Y-directions of the plurality of first refractive index setting units 21 disposed in the matrix configuration along the first surface 10a. In the optical device 110, the refractive index is set for each of the plurality of first refractive index setting units 21, and thus the optical device 110 operates as the optical lens to the transmitting light, namely, develops the function as the optical lens.

For example, in the case where the center in the XY plane of the optical device 110 is taken as the optical axis c, if the refractive index is set to be smaller with being apart from the optical axis c along the XY plane, the optical device 110 functions as a convex lens. On the contrary, if the refractive index is set to be larger with being apart from the optical axis c along the XY plane, the optical device 110 functions as a concave lens. In this way, desired characteristics of the optical device 110 is obtained by setting the refractive index depending on respective positions in the X, Y directions of the plurality of first refractive index units 21.

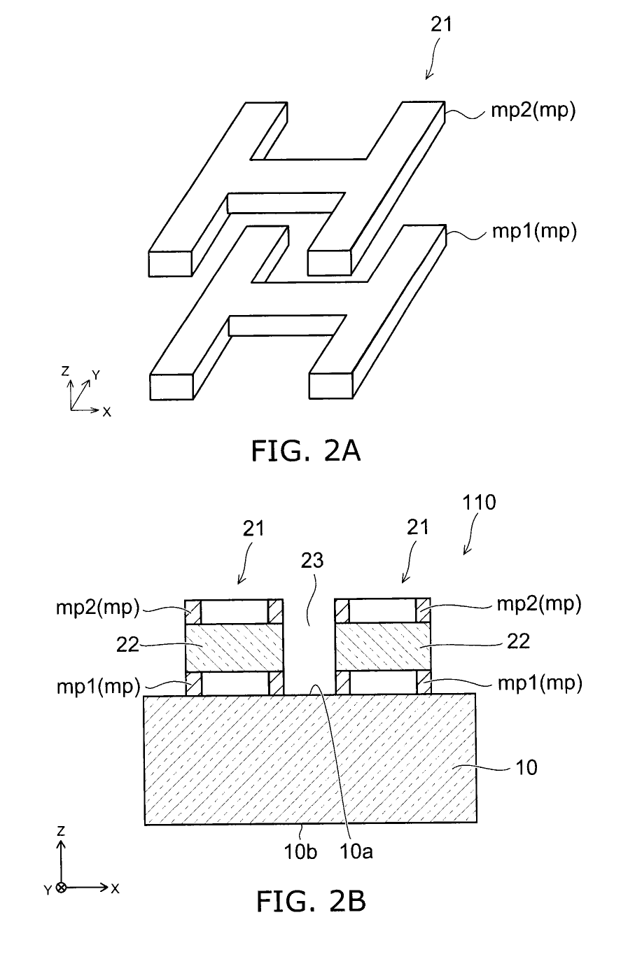

FIGS. 2A and 2B are schematic views illustrating the metal patterns.

FIG. 2A is a schematic perspective view illustrating two metal patterns mp. FIG. 2B is a schematic side view illustrating the metal patterns mp. FIG. 2A shows only metal pattern mp for convenience for description.

As shown in FIG. 2A, at least two metal patterns mp are provided in one first refractive index setting unit 21. In the embodiment, the case where a first metal pattern mp1 and a second metal pattern mp2 are provided in one first refractive index setting unit 21 is illustratively described. In the embodiment, the first metal pattern and the second metal pattern are collectively called as the metal patterns mp.

As shown in FIG. 2A, a shape of the metal patterns mp as viewed in the Z-direction is, for example, H-shaped. The shape of the second metal pattern mp1 as viewed in the Z-direction may be the same as the shape of the second metal pattern mp2 as viewed in the Z-direction. As shown in FIG. 2B, one first refractive index setting unit 21 is disposed with the first metal pattern mp1 and the second metal pattern mp2 with a prescribed spacing in the Z-direction. For example, the first metal pattern mp1 is disposed at a position overlapping with the second metal pattern mp2 as viewed in the Z-direction.

A light transmissive member 22 is provided between the first metal pattern mp1 and the second metal pattern mp2. The spacing between the first metal pattern mp1 and the second metal pattern mp2 is set by a thickness of the light transmissive member 22 in the Z-direction. The light transmissive member 22 is desirably based on a material with as much as low refractive index for development of the characteristics as the meta-material. For example, SiO₂ and a resin are used for the material of the light transmissive member 22.

As shown in FIG. 2B, an intermediate portion 23 having a refractive index lower than the refractive index of the substrate 10 may be provided between adjacent two of the plurality of first refractive index setting units 21. The intermediate portion 23 may either be formed from the light transmissive material (for example, the same material as the light transmissive member 22) or be a gap (space). If the intermediate portion 23 is a gap, a refractive index of a portion between the adjacent two first refractive index setting units 21 is 1 (refractive index of air) and the effective refractive index of the optical device 110 becomes small.

The refractive index of the first refractive index setting units 21 is adjusted by geometrical features of each of two metal patterns mp. For example, the refractive index is adjusted by a size, a pattern width, a spacing of each of the two metal patterns mp.

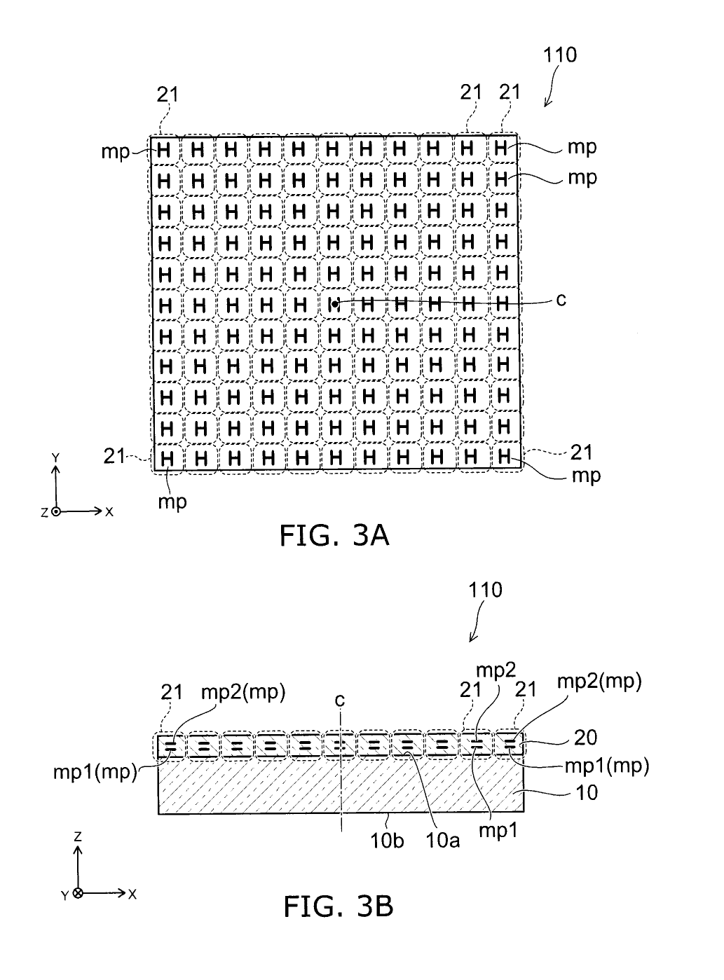

FIGS. 3A and 3B are schematic views illustrating a layout of the metal patterns.

FIG. 3A shows a schematic plan view illustrating the layout of the metal patterns mp, FIG. 3B shows a schematic cross-sectional view illustrating the layout of the metal patterns mp. In the examples shown in FIGS. 3A and 3B, the two metal patterns mp (the first metal pattern mp1 and the second metal pattern mp2 shown in FIG. 2A) are disposed in each of the plurality of first refractive index setting units 21.

In the optical device 110, the geometrical features of the two metal patterns mp are set in accordance with the refractive index for each of the plurality of first refractive index setting units 21. For example, the size of the metal patterns mp as viewed in the Z-direction becomes larger or smaller with being apart from the optical axis c assuming the optical axis c being the center. Thereby, the refractive index in the XY plane of the optical device 110 is appropriately set and the optical device functions as the optical lens even if being a flat plate shape.

Here, the refractive index of the optical lens is determined by a product of square root of each of the dielectric constant and the permeability of the optical lens. Therefore, changing at least one of the dielectric constant and the permeability changes the refractive index. In the optical device 110 according to the embodiment, the refractive index of the first refractive index setting patterns 21 is set by changing at least one of the dielectric constant and the permeability using the metal patterns mp. By setting the refractive index for each of the plurality of first refractive index setting units 21, the optical device 110 is caused to function as the optical lens.

Next, an optical simulation of a change of the refractive index with the metal patterns mp will be described.

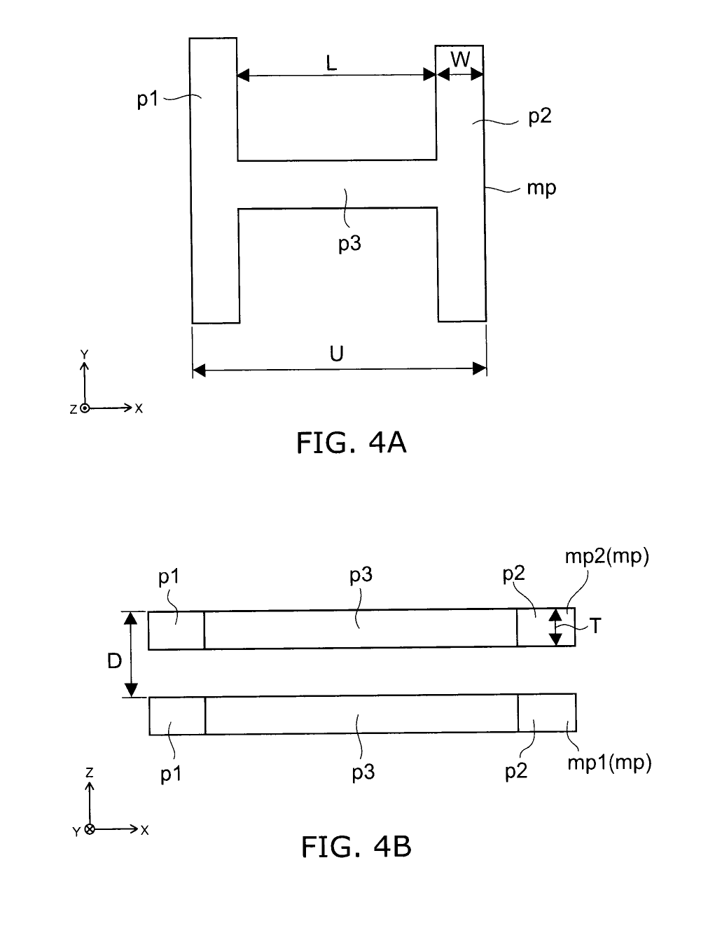

FIGS. 4A and 4B show the definition in performing an optical simulation.

FIG. 4A defines the definition of a dimension of the metal patterns mp as viewed in the Z-direction, and FIG. 4B shows the definition of the metal patterns mp as viewed in the Y-direction. As shown in FIG. 4A, the H-shaped metal pattern mp has two patterns p1 and p2 being parallel each other and a pattern p3 connecting the two patterns p1 and p2.

As shown in FIG. 4A, a distance between inside of the pattern p1 and inside of the pattern 2 is taken as L. A distance between outside of the pattern p1 and outside of the pattern 2 is taken U. A width of the patterns p1 and p2 is taken as W. As shown in FIG. 4B, a thickness of the metal patterns mp is taken as T. A spacing (pitch) between the first metal pattern mp1 and the second metal pattern mp2 is taken as D. The meta-material is formed by disposing a plurality of unit patterns with the desired pitch and periodicity in the X-direction and the Y-direction under the assumption taking a pair of patterns mp1 and mp2 like this as a unit pattern (adjacent unit patterns being not in contact with).

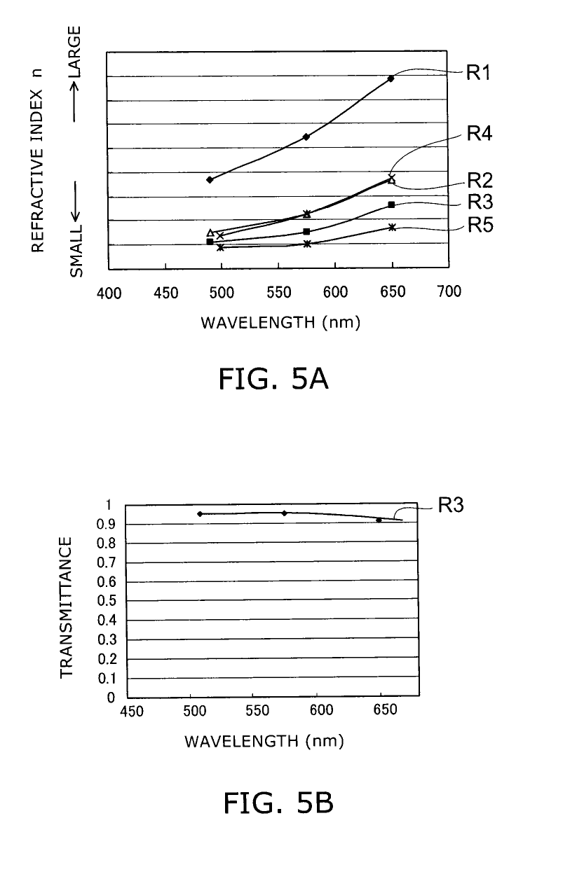

FIGS. 5A and 5B show results of the optical simulation.

A horizontal axis of FIG. 5A represents a wavelength, and a vertical axis represents permeability. A horizontal axis of FIG. 5B represents a wavelength and a vertical axis represents transmittance. In this optical simulation, a change of the refractive index at a wavelength in a visible range depending on the geometric features of the H-shaped metal patterns mp is investigated.

FIG. 5A shows the simulation results of samples R1 to R5. The samples R1 to R3 are two layers metal patterns mp with L=1000 nm. The sample R1 is a pattern with D=30 nm, the sample R2 is a pattern with D=50 nm, the sample R3 is a sample with D=60 nm. The sample R4 is a two layers metal pattern mp with L=1500 nm, D=40 nm. The sample R5 is a three layers metal pattern mp with L=500 nm, D=60 nm.

As seen from the simulation results shown in FIG. 5A, the refractive index changes with the geometrical features of the metal pattern mp. In any of the samples R1 to R5, the refractive index exceeds the refractive index (about 1.45) of SiO₂-based glass at the wavelength in the visible range.

The simulation results shown in FIG. 5B show the transmittance of the sample R3. In the sample R3, the transmittance exceeding 0.9 is obtained at any wavelength in the visible range.

The inventers performed the optical simulations about the various geometrical features of the metal patterns mp including the above simulation results. As a result, it is found that when the spacing U is not more than 2 micrometers (μm), the distance L is not more than 1 μm, the width W is not more than 100 nm, and the thickness T is not more than 100 nm in the metal patterns mp, the refractive index exceeds the refractive index of the SiO₂-based glass and the transmittance is not less than 80% at the wavelength in the visible range.

A material of the metal pattern mp desirably includes at least one selected from gold (Au), silver (Ag), aluminum (Al) and copper (Cu).

In the optical device 110 according to the embodiment, the refractive index of the first refractive index setting units 21 is set from the geometrical feature of the metal patterns mp based on the above simulation results. The refractive index is set for each of the plurality of first refractive index setting units 21, and thus the optical device 110 develops the desired lens characteristics.

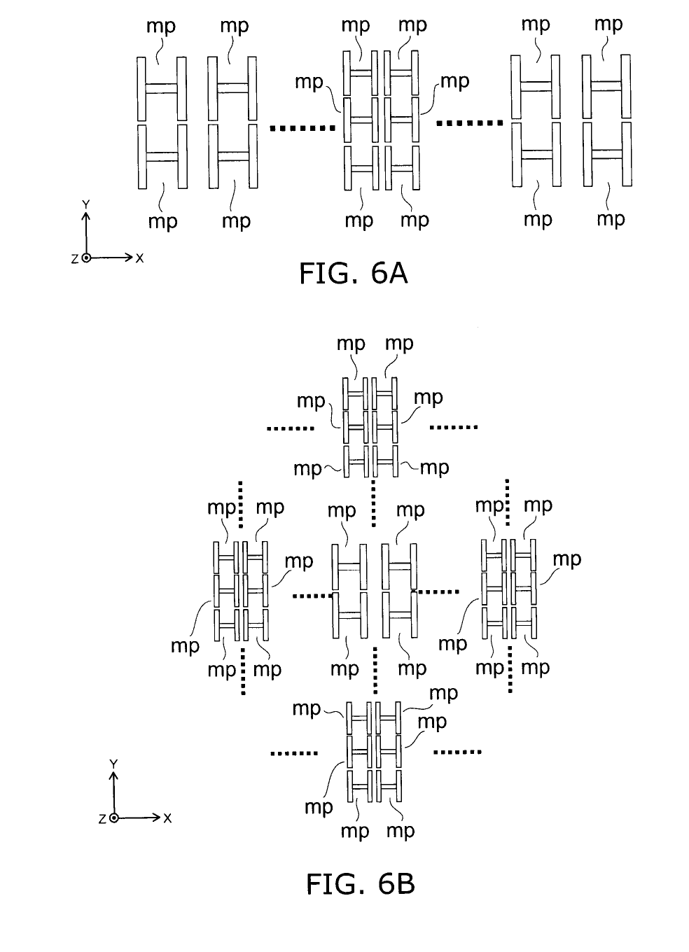

FIGS. 6A and 6B are schematic views showing variation examples of geometrical features of the metal pattern.

FIG. 6A shows an example in which the geometrical features of the metal patterns mp change in one direction. Here, a size of the metal patterns mp increases with being apart from the center in the X-direction. The geometrical features of the metal patterns mp change as shown in FIG. 6A, and thus the optical device 110 develops the optical characteristics such as a cylindrical mirror.

FIG. 6B shows an example in which the geometrical features of the geometrical patterns mp change tow-dimensionally. Here, a size of the metal patterns mp increases with being apart from the center in the X-direction and the Y-direction. The geometrical features of the metal patterns mp change as shown in FIG. 6A, and thus the optical device 110 develops the optical characteristics such as a convex lens or a concave lens.

The simulation results shown in FIG. 5A show the tendency of increase of the refractive index with increasing distance L. From this result, it can be said that as shown in FIG. 6B, if the distance L of the metal patterns mp decreases with being apart from the center in the X-direction and the Y-direction, the refractive index decreases from the center toward outside. Therefore, the distance L of the metal patterns mp changes as shown in FIG. 6B and thus the optical device 110 results in functioning as the convex lens.

### Second Embodiment

Next, the second embodiment will be described. A method for manufacturing the optical device 110 will be described in the second embodiment.

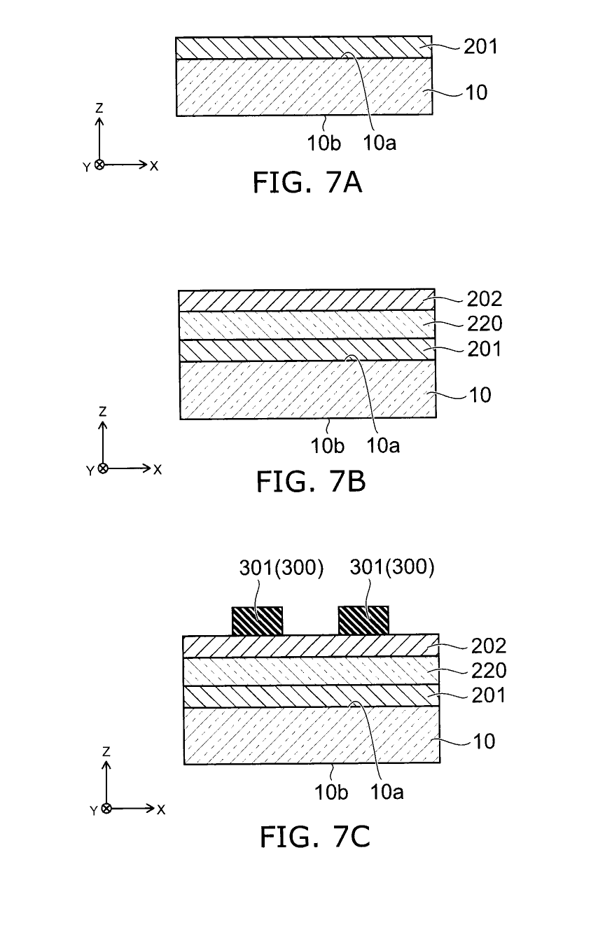

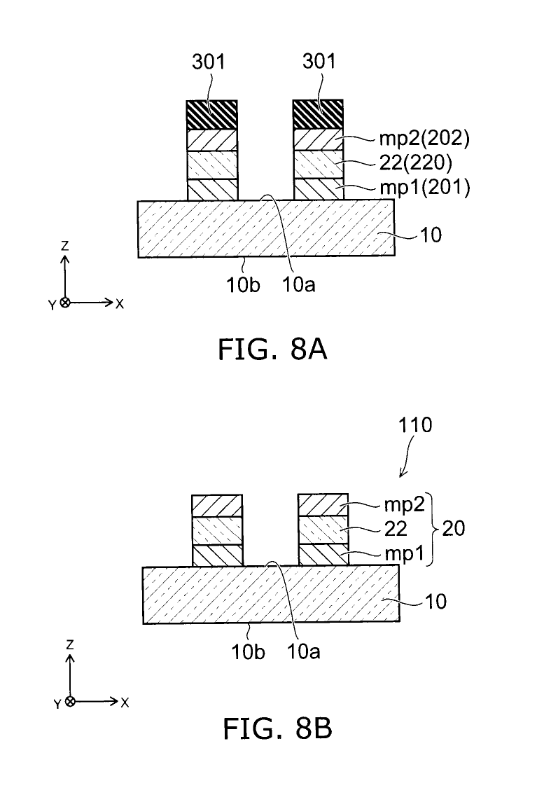

FIG. 7A to FIG. 8B are schematic cross-sectional views illustrating a method for manufacturing the optical device.

First, as shown in FIG. 7A, a substrate 10 such as glass etc. is prepared. Next, a first metal film 201 is formed on the first surface 10a of the substrate 10. A material of the first metal film 201 includes at least one selected from Au, Ag, Al and Cu. The first metal film 201 is formed by, for example, sputtering.

Next, as shown in FIG. 7B, a light transmissive material film 220 is formed on the first metal film 201. The light transmissive material film 220 includes, for example, SiO₂. Next, a second metal film 202 is formed on the light transmissive material film 220. A material of the second metal film 202 includes at least one selected from Au, Ag, Al and Cu. The second metal film 202 is formed by, for example, sputtering.

The embodiment illustratively describes the cases of forming the two layers metal patterns mp. In forming metal patterns mp with not less than 3 layers, metal films in accordance with the layer number may be stacked via light transmissive material films.

Next, as shown in FIG. 7C, a resist film 300 is applied on the second metal film 202, and a resist pattern 301 is formed by lithography and etching. A shape of the resist pattern 301 as viewed in the Z-direction corresponds to a shape of the formed metal pattern mp.

Next, as shown in FIG. 8A, the second metal film 202, the light transmissive material film 220 and the first metal film 201 are collectively etched using the resist pattern as a mask. Etching includes, for example, RIE (Reactive Ion Etching) and IBE (Ion Beam Etching). The second metal film 202 left without being etched in this etching forms the second metal pattern mp2. The first metal film 201 left without being etched in this etching forms the first metal pattern mp1. After the etching, the resist pattern 301 is removed.

Thereby, as shown in FIG. 8B, the first optical layer 20 is formed on the first surface 10a of the substrate 10, and the optical device is completed. The first optical layer 20 is provided with the plurality of first refractive index setting units 21. Each of the plurality of first refractive index setting units 21 is provided with two metal patterns mp. The intermediate portion 23 is provided between the two adjacent first refractive setting units 21 by etching and removing the second metal film 202, the light transmissive material film 220 and the first metal film 201.

In the method for manufacturing the optical device 110, the shape of the metal pattern mp is set by the shape of the resist pattern 301. Therefore, the refractive index of the first refractive index setting unit 21 is set by the shape of the resist pattern 301. The first metal pattern mp1 and the second metal pattern mp2 are collectively formed by etching using the resist pattern 301 as a mask. That is, the two metal patterns mp are formed in one etching process.

If FIB (Focused Ion Beam) is used for etching the second metal film 202, the light transmissive material film 220 and the first metal film 201, the forming process of the resist pattern 301 becomes unnecessary.

### Third Embodiment

Next, a third embodiment will be described.

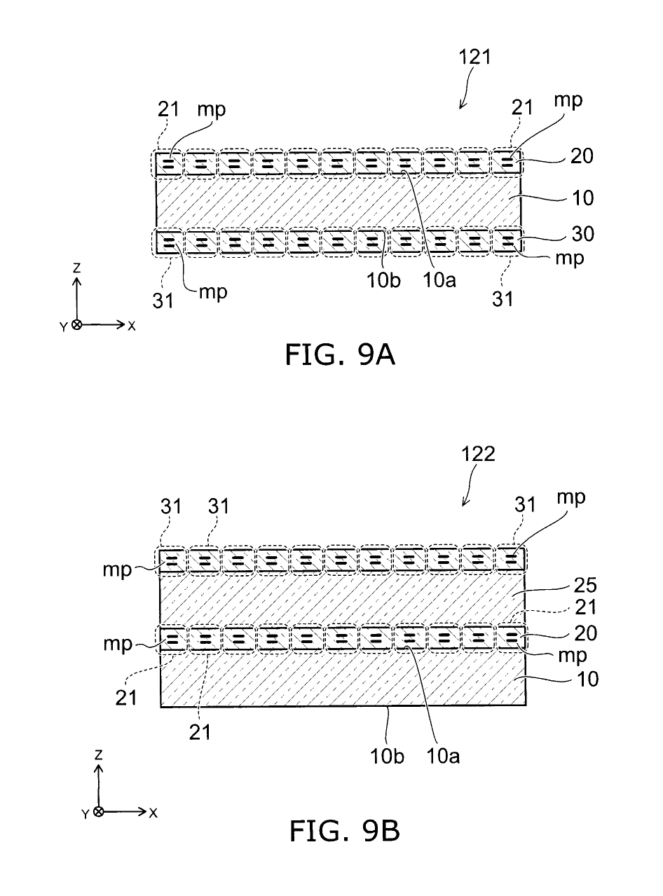

FIGS. 9A and 9B are schematic cross-sectional views illustrating optical devices according to the third embodiment.

An optical device 121 shown in FIG. 9A includes a second optical layer 30 provided on the second surface 10b of the substrate 10 in addition to the first optical layer 20 provided on the first surface 10a of the substrate 10. The second optical layer 30 includes a plurality of second refractive index setting units 31. The plurality of refractive index setting units 31 are disposed two dimensionally along the second surface 10b.

Each of the plurality of second refractive index setting units 31 includes two metal patterns mp adjusting permeability. Each of the plurality of refractive index setting units 31 has a refractive index set by the two metal patterns mp. The optical device 121 develops the function as the optical lens on a front surface and a back surface of the substrate 10 through the action of the first optical layer 20 provided on the first surface 10a of the substrate 10 and the second optical layer 30 provided on the second surface 10b of the substrate 10.

In order to manufacturing the optical device 121, it is only necessary to, for example, form two optical devices 110 in the process shown in FIG. 7A to FIG. 8B and to stick the second surfaces 10b of the substrate 10 of the two optical devices 110 together each other.

An optical device 122 shown in FIG. 9B has the configuration stacking the first optical layer 20 and the second optical layer 30 on the first surface 10a of the substrate 10. The optical device 122 develops the function as two optical lenses through the action of the first optical layer 20 and the second optical layer 30 provided on the first surface 10a of the substrate 10. The intermediate layer 23 and the second optical layer 30 may be formed in multiple pairs on the first optical layer 20. Thereby, not less than 3 optical lenses are formed on the first surface 10a.

In order to manufacture the optical device 122, it is only necessary to, for example, form two optical devices 110 in the process shown in FIG. 7A to FIG. 8B and to stack the two optical devices 110 in the Z-direction.

Next, disposition example of the two metal patterns mp will be described.

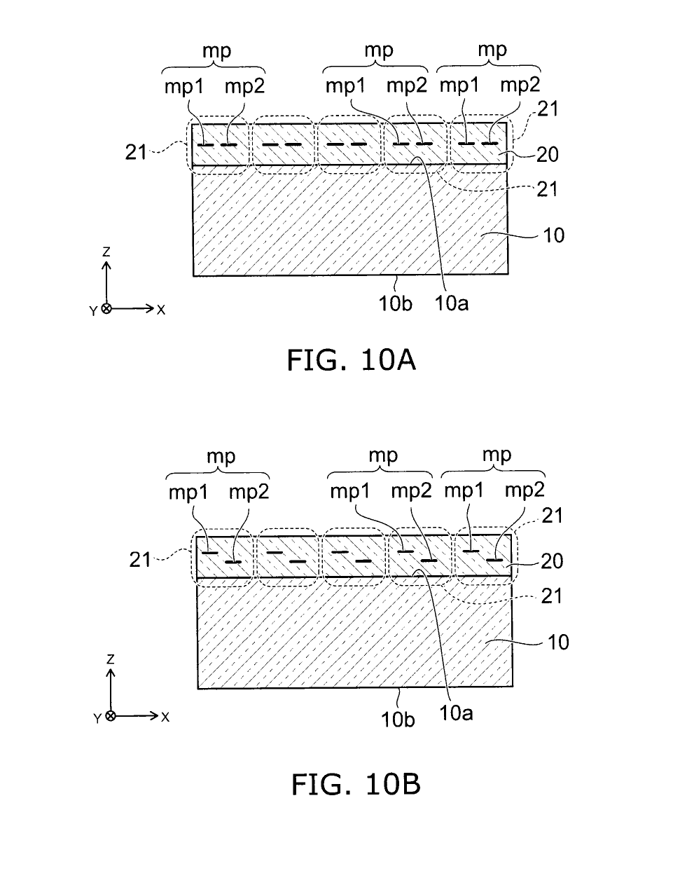

FIGS. 10A and 10B are schematic views illustrating the disposition of two metal patterns.

In the disposition example shown in FIG. 10A, two metal patterns mp (first metal pattern mp1 and second metal pattern mp2) are disposed along the first surface 10a of the substrate 10.

The first metal pattern mp1 shown in FIGS. 2A and 2B is disposed to overlap the second metal pattern in a direction (Z-direction) orthogonal to the first surface 10a. On the contrary, the first metal pattern mp1 shown in FIG. 10A is disposed in juxtaposition with the second metal pattern mp2, for example, in the X-direction along the first surface 10a. A height of the first metal pattern mp1 in the Z-direction is the same as a height of the second metal pattern mp2 in the Z-direction.

In the disposition of the two metal patterns mp like this, the refractive index is adjusted by the spacing between the two metal patterns mp along the first surface 10a in addition to dimensions (the distance L, U and the width W shown in FIG. 4A, the thickness T shown in FIG. 4B) of the metal patterns mp.

The first metal pattern mp1 shown in FIG. 10B is disposed in juxtaposition with the second metal pattern mp2, for example, in the X-direction along the first surface 10a. The height of the first metal pattern mp1 in the Z-direction is different from the height of the second metal pattern mp2 in the Z-direction.

In the disposition of the two metal patterns mp like this, the refractive index is adjusted by the spacing (the shortest distance) between the two metal patterns mp in addition to dimensions (the distance L, U and the width W shown in FIG. 4A, the thickness T shown in FIG. 4B) of the metal patterns mp.

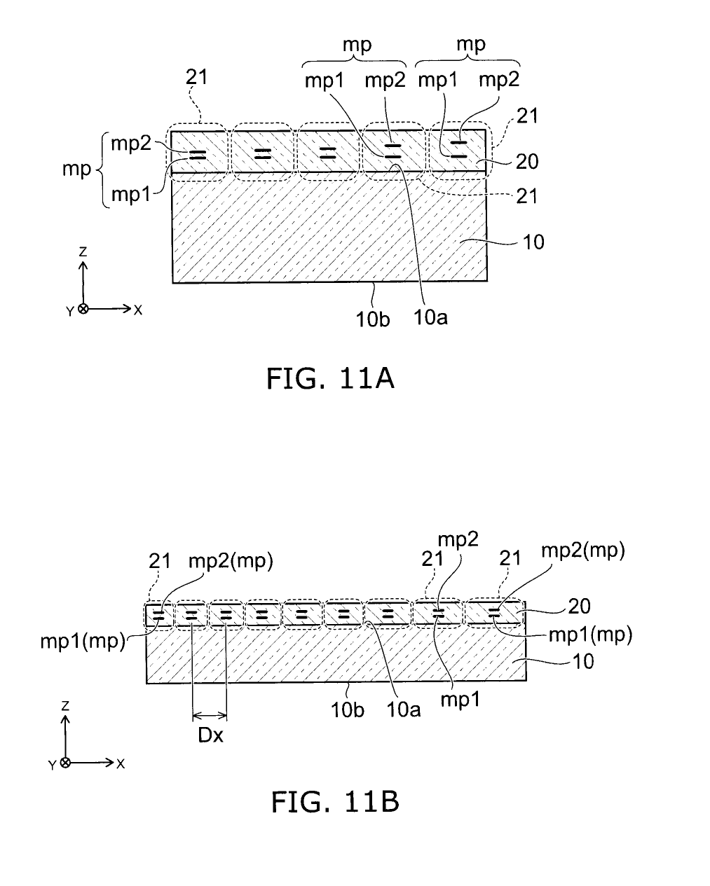

FIG. 11A FIG. 11B are schematic views illustrating distances between the two metal patterns.

In the example shown in FIG. 11A, for each of the plurality of first refractive index setting units 21, a spacing (pitch) D of the two metal patterns mp (the first metal pattern mp1 and the second metal pattern mp2) in the Z-direction is appropriately set. The refractive index of the first refractive index setting unit 21 is set by the spacing D. In the example shown in FIG. 11A, for the plurality of first refractive index setting units 21, the spacing D between the two metal patterns mp changes gradually.

In the example shown in FIG. 11B, the spacing Dx between metal patterns mp in each of the adjacent two first refractive index setting units 21 in the X-direction is appropriately set. In the case where the plurality of first refractive index setting units 21 are disposed in each of the X-direction and the Y-direction, the spacing between the two adjacent metal patterns mp in the Y-direction and the spacing in the X-direction may be appropriately set. When the spacing between the adjacent metal patterns mp (for example, the spacing Dx in the X-direction) increases, a low refractive index region other than the metal patterns mp becomes large. Thereby, the effective refractive index of the first optical layer 20 decreases.

As shown in FIG. 10A to FIG. 11B, the geometrical features of the two metal patterns mp and the geometrical features of the adjacent metal patterns mp set the refractive index of the first refractive index setting units 21, and the optical device 110 results in functioning as the optical lens.

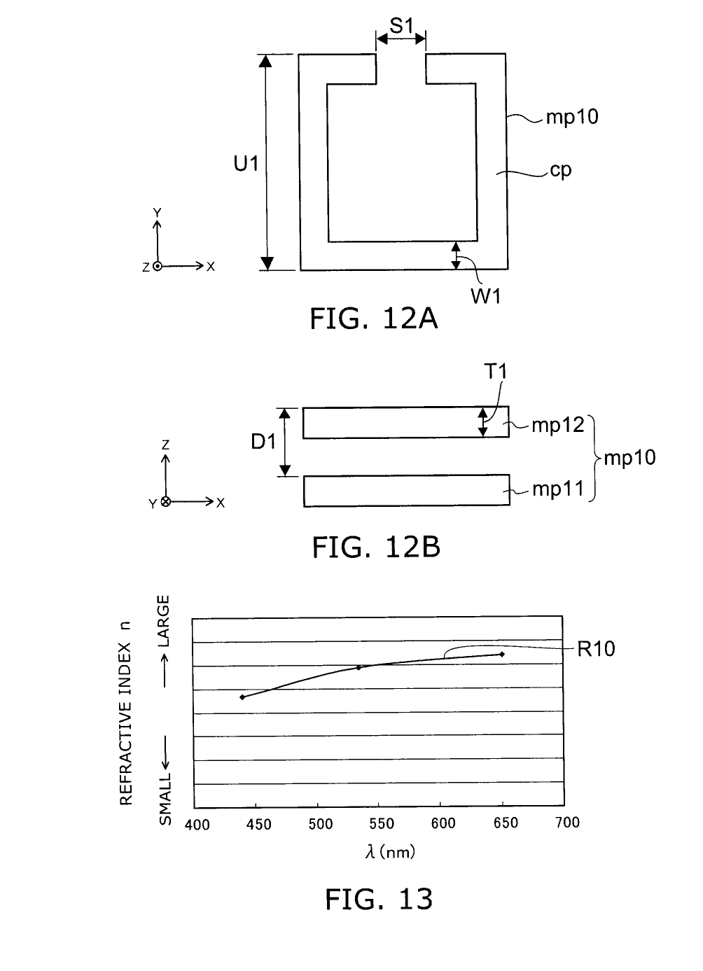

FIGS. 12A and 12B are schematic views illustrating other shapes of the metal patterns.

FIG. 12A shows a schematic plan view of a metal pattern mp 10, and FIG. 12B shows a schematic side view of the metal pattern mp10. As shown in FIG. 12A, a shape of the metal pattern mp10 as viewed in the Z-direction has a shape with a cut portion of a ring pattern cp. As shown in FIG. 12B, the metal pattern mp10 has a first metal pattern mp11 and a second metal pattern mp12. In the embodiment, the first metal pattern mp11 and the second metal pattern mp12 are collectively called as the metal pattern mp10.

The shape of the first metal pattern mp11 as viewed in the Z-direction may be the same as the shape of the second metal pattern mp12 as viewed in the Z-direction. As shown in FIG. 12B, the second metal pattern mp12 is disposed with a predetermined spacing in the Z-direction to the first metal pattern mp11. For example, the first metal pattern mp11 is disposed at a position overlapping the second metal pattern mp12 as viewed in the Z-direction.

As shown in FIG. 12A, a size of the metal pattern mp10 in the Y-direction is taken as U1, a width of the metal pattern mp10 is taken as W1, and a spacing of the cut portion of the ring pattern cp is taken as S1. As shown in FIG. 12B, a thickness of the metal pattern mp10 is taken as T1. A spacing (pitch) between the first metal pattern mp11 and the second metal pattern mp12 is taken as D1. The meta-material is formed by disposing a plurality of unit patterns with the desired pitch and periodicity in the X-direction and the Y-direction under the assumption taking a pair of patterns mp11 and mp12 like this as a unit pattern (adjacent unit patterns being not in contact with).

FIG. 13 shows the optical simulation result.

A horizontal axis of FIG. 13A represents a wavelength, and a vertical axis represents permeability. A horizontal axis of FIG. 13B represents a wavelength and a vertical axis represents transmittance. In this optical simulation, a change of the refractive index at a wavelength in a visible range depending on the predetermined metal pattern mp10 is investigated.

FIG. 13 shows the simulation results of a sample R10. In the sample R10, the size U1=1000 nm, the width W1=100 nm, the spacing S1=100 nm, the thickness T1=100 nm, the spacing D1=100 nm. As seen from the simulation results shown in FIG. 13, the wavelength dependence of the refractive index of the sample R10 tends to be smaller than the wavelength dependences of the sample R1 to R5 shown in FIG. 5A.

The inventers performed the optical simulations about the various geometrical features of the metal patterns mp10 including the above simulation results. As a result, it is found that when the size U1 is not more than 2 μm, the width W1 is not more than 100 nm, and the thickness T1 is not more than 100 nm, the spacing S1 is not more than 200 nm in the metal patterns mp10, the refractive index exceeds the refractive index of the SiO₂-based glass and the transmittance is not less than 80% at the wavelength in the visible range.

A material of the metal pattern mp10 desirably includes at least one selected from Au, Ag, Al and Cu.

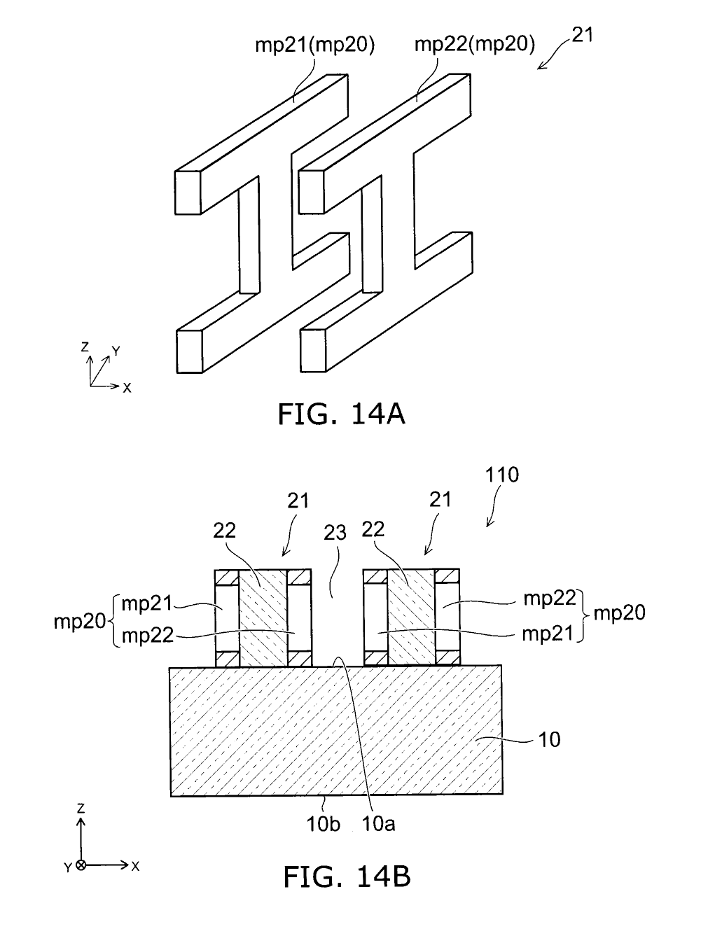

FIGS. 14A and 14B are schematic views illustrating other shapes of the metal patterns.

FIG. 14A is a schematic perspective view illustrating two metal patterns mp20. FIG. 14B is a schematic side view illustrating the metal patterns mp20. As shown in FIG. 14A, the two metal patterns mp20 has a configuration in which the two metal patterns mp (the first metal pattern mp1 and the second metal pattern mpg) shown in FIG. 2A are rotated by 90 degree, respectively. In the embodiment, the first metal pattern mp21 and the second metal pattern mp22 are collectively called as the metal patterns mp20.

As shown in FIG. 14A, a shape of the metal patterns mp20 as viewed in the X-direction is H-shaped. A shape of the first metal pattern mp21 as viewed in the X-direction may be the same as a shape of the second metal pattern mp22 as viewed in the X-direction. As shown in FIG. 14B, in one first refractive index setting unit 21, the first metal pattern mp21 and the second metal pattern mp22 are disposed with a predetermined spacing in the X-direction. For example, the first metal pattern mp21 is disposed at a position overlapping the second metal pattern mp22 as viewed in the X-direction.

The refractive index of the first refractive index setting units 21 is adjusted by geometrical features of each of two metal patterns mp20. The two metal patterns mp20 like this are provided in the first refractive index setting unit 21, and thereby the refractive index in the XY plane of the optical device 110 is appropriately set and the optical device 110 results in functioning as the optical lens even if being in flat shaped.

In the embodiment described above, the shape of the metal pattern is not limited to the metal patterns mp, mp10 and mp20. The shape of the metal pattern may be a shape which suppresses occurrence of an eddy current due to light transmitting the metal pattern. The metal pattern is desired to be non-resonant to visible light. A high refractive index with a broad band is obtained by using the non-resonant metal pattern.

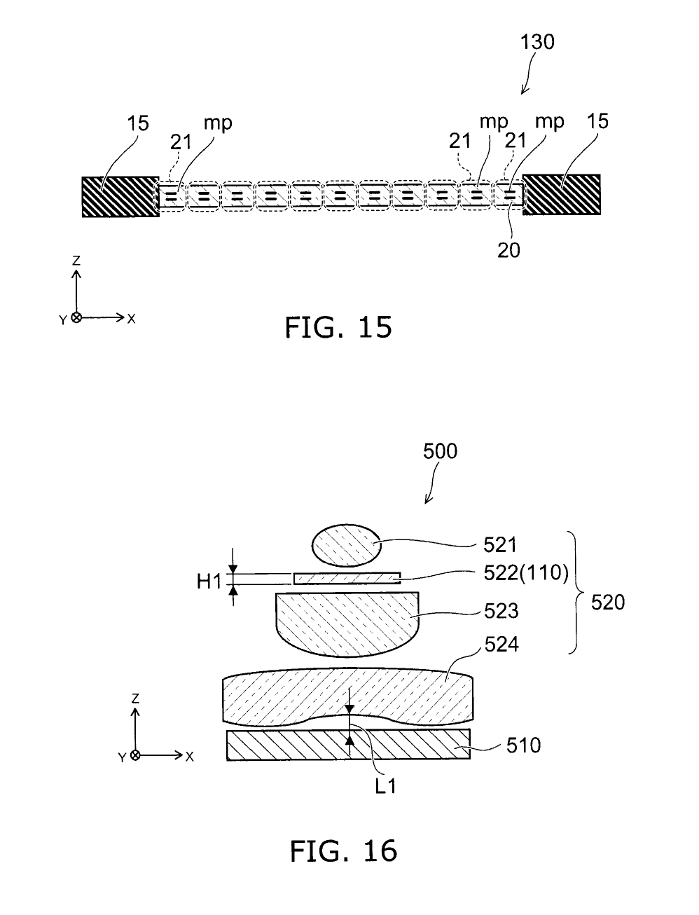

FIG. 15 is a schematic view illustrating another configuration of the optical device.

The optical device 130 shown in FIG. 15 includes a supporter 15 and a first optical layer 20. In the optical device 130, the first optical layer 20 is supported by the supporter 15. For example, the supporter 15 is provided so as to surround a side surface of the first optical layer 20. That is, the optical device 130 does not include a substrate 10. The first optical layer 20 is supported by the supporter 15 instead of the substrate 10. In the optical device 130, a refractive index is set for each of the plurality of first refractive index setting units 21, and thereby the optical device 130 develops the function as the optical lens similar to the optical device 110.

### Fourth Embodiment

Next, a fourth embodiment will be described.

FIG. 16 is a schematic cross-sectional view illustrating a sold-state imaging device according to the fourth embodiment.

As shown in FIG. 16, a solid-state imaging device 500 includes a solid-state imaging element 510 and a group of lenses 520. The solid-state imaging element 510 is a photoelectric conversion element receiving light entering through the group of lenses 520 to convert the light to an electric signal per a pixel unit. The solid-state imaging element 510 includes multiple pixels. The multiple pixels are disposed in a line or two dimensionally.

The group of lenses 520 includes multiple optical lenses (for example, optical lenses 521 to 524). The optical device 110 according to the embodiment is applied to the optical lens 522, one of the optical lenses 521 to 524. The optical lens 522 is, for example, a lens for suppression of chromatic aberration. The optical device 121, 122 and 130 may be applied to the optical lens 522.

Refractive indexes of the optical devices 110, 121, 122 and 130 applied to the optical lens 522 are higher than a refractive index of an optical lens based on SiO₂-based glass. Therefore, applying the optical devices 110, 121, 122 and 130 to the optical lens 522 makes the thickness of the optical lens 522 thinner.

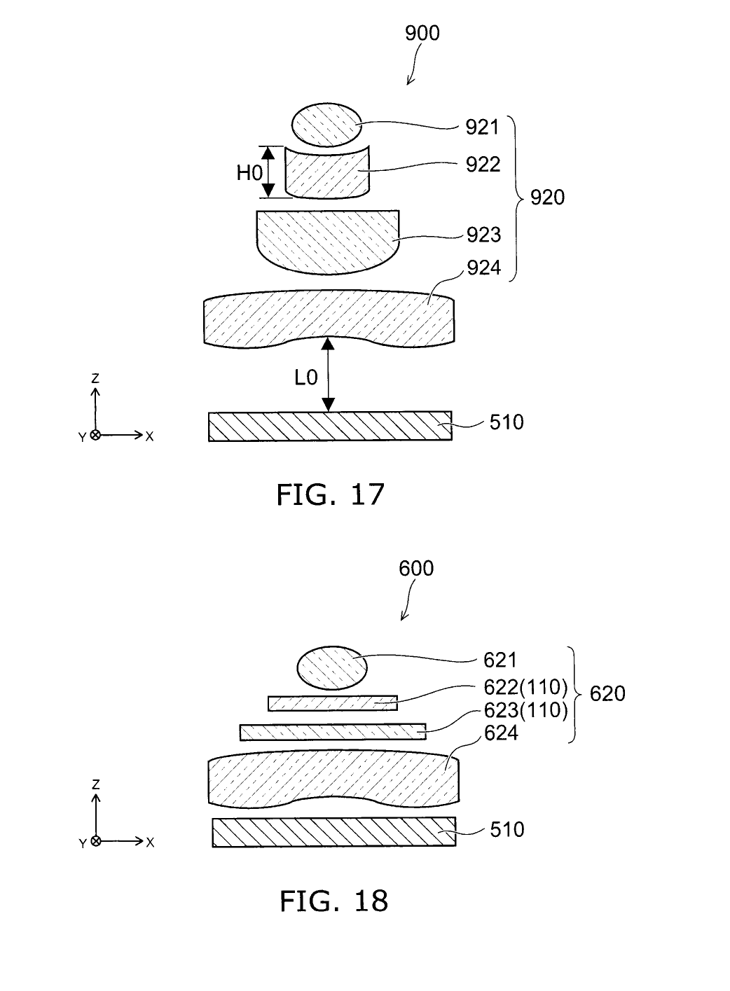

FIG. 17 is a schematic cross-sectional view illustrating a solid-state imaging device according to a reference example.

A solid-state imaging device 900 shown in FIG. 17 includes the solid-state imaging element 510 and a group of lenses 920. The group of lenses 920 includes multiple optical lenses (for example, optical lenses 921 to 924). SiO₂-based glass is used for the multiple optical lenses 921 to 924 included in the group of lenses 920.

Here, a thickness (length in optical axis direction) of the optical lens 922 is taken as H0 when SiO₂-based glass with a refractive index of about 1.45 is used as the optical lens 920. A thickness (length in optical axis direction) of the optical lens 522 of the group of lenses 520 shown in FIG. 16 is taken as H1. When the optical device 110 with an average refractive index of 3.0 is, for example, applied to the optical lens 522, the thickness H1 of the optical lens 522 is about ⅓ compared with the thickness H0 of the optical lens 922.

Here, when a distance between the optical lens 924 and the solid-state imaging element 510 of the solid-state imaging device 900 shown in FIG. 17 is taken as L0, and a distance between the optical lens 524 and the solid-state imaging element 510 of the solid-state imaging device 500 is taken as L1, the distance L1 is shorter than the distance L0. This is because the optical device 110 has a negative Abbe number (see FIG. 5A). The optical device 110 having the negative Abbe number is used for the optical lens 522 for suppressing the chromatic aberration, and thereby increase of an optical oath length is suppressed and the distance L1 is shortened. Thereby, the whole of the solid-sate imaging device 500 can be downsized.

FIG. 18 is a schematic cross-sectional view illustrating another solid-sate imaging device according to the fourth embodiment.

As shown in FIG. 18, a solid-sate imaging device 600 includes the solid-sate imaging element 510 and a group of lenses 620. The group of lenses 620 includes multiple optical lenses (for example, optical lenses 621 to 624). The optical device 110 according to the embodiment is applied to the optical lenses 622 and the optical lens 623 of the optical lenses 621 to 624. The optical devices 121, 122 and 130 may be applied to the optical lenses 622 and the 623.

Applying the optical devices 110, 121, 122 and 130 to the two optical lenses 622 and 623 of the group of lenses 620 makes a thickness of the group of lenses 620 thinner than the thickness of the group of lenses 520. Therefore, the solid-state imaging device 500 is downsized compared with the solid-state imaging device 500.

The optical devices 110, 121, 122 and 130 may be applied to 3 or more optical lenses of the multiple optical lenses 621 to 624 of the group of lenses 620. Thereby, the group of lenses 620 is further thinned and downsizing of the solid-state imaging device 600 is achieved.

In the solid-state imaging devices 500 and 600, the examples of applying the optical devices 110, 121, 122 and 130 to the optical lens of the groups of lenses 520 and 620 have been described, however the optical devices 110, 121, 122 and 130 may be applied to other than the groups of lenses 520 and 620. For example, the configuration similar to providing the multiple optical lenses in the XY plane through adjusting the refractive index in the XY plane of the optical devices 110, 121, 122 and 130 may be applied. According to the configuration like this, for example, the optical devices 110, 121, 122 and 130 are applied to micro array having a lens disposed for every pixel.

As described above, according to the embodiment, an optical device having a desired refractive index, a solid-state imaging device and a method for manufacturing the optical device can be obtained.

Hereinabove, exemplary embodiments of the invention are described with reference to the specific examples. However, the embodiments of the invention are not limited to these specific examples. For example, the case where the substrate 10 has a planar shape is exemplified, however at least one of the first surface 10a and the second surface 10b of the substrate 10 may be curved. A person skilled in the art may appropriately add the design variation to the specific examples, and these variations are within the scope of the embodiments to the extent that the features of the embodiments are included. Every component included in the specific examples described previously, its disposition, materials, conditions, shapes, sizes or the like are not limited to the illustration and may be appropriately modified.

Every component included in the embodiments described previously can be complexed as long as technically possible, and these complexities are encompassed within the scope of the embodiments as long as including the features of the embodiments. Various other variations and modifications can be conceived by those skilled in the art within the spirit of the invention, and it is understood that such variations and modifications are also encompassed within the scope of the embodiments.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. An optical device comprising:
a substrate having a first surface and a second surface, the second surface being on an opposite side of the first surface; and
a first optical layer provided on the first surface and including a plurality of first refractive index setting units disposed along the first surface,
each of the first refractive index setting units having a plurality of metal patterns, the metal patterns providing different permeability to the each of the first refractive index setting units, and the each of the first refractive index setting units having a refractive index in accordance with the permeability.

2. The device according to claim 1 wherein the first refractive index setting units are disposed two dimensionally along the first surface.

3. The device according to claim 1 wherein
the refractive index of the first refractive index setting units changes along the first surface, and
the first optical layer operates as a lens to transmitting light.

4. The device according to claim 1 wherein the refractive index is a refractive index to visible light.

5. The device according to claim 1 wherein
the each of the first refractive index setting units has two of the metal patterns, and
the two of the metal patterns are disposed in a direction orthogonal to the first surface to overlap each other.

6. The device according to claim 1 wherein a shape of a first metal pattern of the metal patterns is identical with a shape of a second metal pattern of the metal patterns.

7. The device according to claim 6 wherein a shape of the first metal pattern as viewed in a direction orthogonal to the first surface is identical with a shape of the second metal pattern as viewed in the direction.

8. The device according to claim 1 wherein
the first optical layer has an intermediate potion,
the intermediate portion is provided between two adjacent first refractive index setting units of the first refractive index setting units and has a refractive index lower than a refractive index of the substrate.

9. The device according to claim 1, further comprising:
a second optical layer including a plurality of second refractive index setting units disposed along the first surface,
each of the plurality of second refractive index setting units having a plurality of metal patterns, the metal patterns providing different permeability to the each of the second refractive index setting units, and the each of the plurality of second refractive index setting units having a refractive index in accordance with the permeability.

10. The device according to claim 9 wherein the second optical layer is provided on the second surface of the substrate.

11. The device according to claim 9 wherein the second optical layer is provided on the first optical layer.

12. A solid-state imaging device comprising:
a solid-state imaging element; and
an optical device disposed on an optical axis of the solid-state imaging element,
the optical device including
a substrate having a first surface and a second surface, the second surface being on an opposite side of the first surface,
a first optical layer provided on the first surface and having a plurality of refractive index setting units disposed along the first surface,
each of the plurality of refractive index setting units having a plurality of metal patterns, the metal patterns providing different permeability to the each of the refractive index setting units, and the each of the refractive index setting units having a refractive index in accordance with the permeability.

13. The device according to claim 12 wherein the refractive index setting units are disposed two dimensionally along the first surface.

14. The device according to claim 12 wherein
the refractive index of the refractive index setting units changes along the first surface, and
the first optical layer operates as a lens to transmitting light.

15. A method for manufacturing an optical device, the optical device including a substrate having a first surface and a second surface on an opposite side of the first surface; and
a first optical layer provided on the first surface and including a plurality of first refractive index setting units disposed along the first surface,
each of the first refractive index setting units having a plurality of metal patterns, the metal patterns providing different permeability to the each of the first refractive index setting units, and the each of the first refractive index setting units having a refractive index in accordance with the permeability,
the method comprising:
forming a stacked body including a first metal film and a second metal film sequentially stacked on the first surface;
forming a mask on the stacked body;
forming two of the metal patterns by etching the stacked body via the mask to pattern the first metal film and the second metal film.

16. The method according to claim 15 wherein the refractive index setting units are disposed two dimensionally along the first surface.

17. The method according to claim 15 wherein the refractive index of the first refractive index units changes along the first surface.
